(19) United States
(12) Patent Application Publication
(10) Pub. No.: US 2022/0379209 A1
(43) Pub. Date: Dec. 1, 2022

(54) VIRTUAL RESOURCE DISPLAY METHOD AND RELATED APPARATUS

(71) Applicant: Tencent Technology (Shenzhen) Company Limited, Shenzhen (CN)

(72) Inventors: Li YAO, Shenzhen (CN); Zhihong LIU, Shenzhen (CN)

(73) Assignee: Tencent Technology (Shenzhen) Company Limited, Shenzhen (CN)

(21) Appl. No.: 17/885,297

(22) Filed: Aug. 10, 2022

Related U.S. Application Data
(63) Continuation of application No. PCT/CN2021/098565, filed on Jun. 7, 2021.

(30) Foreign Application Priority Data
Jul. 9, 2020 (CN) 202010658697.7

(51) Int. Cl. A63F 13/52; A63F 13/837

(52) U.S. Cl. CPC A63F 13/52; A63F 13/837

(57) ABSTRACT

A virtual resource display method is provided. In the method, at least one target virtual object is displayed in a virtual scene in response to at least one target virtual item of the virtual scene reaching a target state through user interaction. The at least one target virtual object is controlled to move in the virtual scene in response to a shooting operation on the at least one target virtual object. A target virtual resource is displayed in the virtual scene in response to a location of the at least one target virtual object meeting a first target condition.

### RELATED APPLICATIONS

The present application is a continuation of International Application No. PCT/CN2021/098565, entitled “VIRTUAL RESOURCE DISPLAY METHOD AND RELATED DEVICE” and filed on Jun. 7, 2021, which claims priority to Chinese Patent Application No. 202010658697.7, entitled “VIRTUAL RESOURCE DISPLAY METHOD AND APPARATUS, ELECTRONIC DEVICE, AND STORAGE MEDIUM” filed on Jul. 9, 2020. The entire disclosures of the prior applications are hereby incorporated by reference in their entirety.

### FIELD OF THE TECHNOLOGY

This application relates to the field of computer technologies, including to virtual resource display.

### BACKGROUND OF THE DISCLOSURE

With development of multimedia technologies and diversification of terminal functions, there are increasingly more types of games that can be played on a terminal. Shooting games are a relatively popular game. The terminal can display a virtual scene in an interface and display a virtual object in the virtual scene. The virtual scene may further display a virtual resource. The virtual resource can refer to a resource that can help a player play the game, and may be, for example, a virtual gun or a virtual medicine. The virtual object can pick up the virtual resource in the virtual scene and play against other virtual objects.

Currently, in a virtual resource display method, virtual resources are usually displayed at some location in the virtual scene at the beginning of a competition. A user can control the virtual object to search for the virtual resources at the corresponding location and approach the virtual resources to pick up the virtual resources; or defeat other virtual objects to obtain virtual resources in backpacks of the virtual objects.

### SUMMARY

In view of this, embodiments of this disclosure include a virtual resource display method and a related apparatus. The embodiments can provide a virtual resource display triggering manner, which can motivate users to operate, make the virtual resource display manner more interesting, and improve a virtual resource display effect.

According to one aspect, a virtual resource display method is provided. In the method, at least one target virtual object is displayed in a virtual scene in response to at least one target virtual item of the virtual scene reaching a target state through user interaction. The at least one target virtual object is controlled to move in the virtual scene in response to a shooting operation on the at least one target virtual object. A target virtual resource is displayed in the virtual scene in response to a location of the at least one target virtual object meeting a first target condition.

According to another aspect, a virtual resource display apparatus is provided, the apparatus includes processing circuitry configured to display at least one target virtual object in a virtual scene in response to at least one target virtual item of the virtual scene reaching a target state through user interaction. The processing circuitry is configured to control the at least one target virtual object to move in the virtual scene in response to a shooting operation on the at least one target virtual object. Further, the processing circuitry is configured to display a target virtual resource in the virtual scene in response to a location of the at least one target virtual object meeting a first target condition.

According to another aspect, an electronic device is provided, including one or more processors and one or more memories, the one or more memories storing at least one piece of program code, and the at least one piece of program code being loaded and executed by the one or more processors to implement the operations performed in the virtual resource display method according to any one of the foregoing aspects.

According to another aspect, a non-transitory computer-readable storage medium is provided. The non-transitory computer-readable storage medium stores instructions which when executed by at least one processor cause that least one processor to perform the virtual resource display method according to any one of the foregoing aspects.

According to another aspect, a computer program product or a computer program that includes instructions is provided, the computer program product or the computer program, when run on a computer, enabling the computer to perform the virtual resource display method according to any one of the foregoing aspects.

In the embodiments of this disclosure, at least one target virtual object is displayed in a virtual scene when at least one target virtual item of the virtual scene reaches a target state through interaction. This provides a flexible and highly interesting display trigger manner for the at least one target virtual object. Subsequently, the at least one target virtual object can be controlled to move in the virtual scene by shooting the at least one target virtual object. Such a novel control manner of causing a target virtual object to move through a shooting operation instead of directly controlling actions of the target virtual object can be much more interesting. In addition, a target virtual resource can be displayed when a location of the at least one target virtual object meets a first target condition. This provides a novel virtual resource display triggering manner. The target virtual resource needs to be triggered by the foregoing operation for display, instead of being directly displayed in the virtual scene at the beginning of a competition. Therefore, the trigger manner is novel and can motivate users to operate, thereby effectively making a virtual resource display manner more interesting and providing a better virtual resource display effect.

### BRIEF DESCRIPTION OF THE DRAWINGS

To describe technical solutions in embodiments of this disclosure, the following briefly describes the accompanying drawings for describing the embodiments. The accompanying drawings in the following description show merely some embodiments of this disclosure. Other embodiments are within the scope of this disclosure.

FIG. 1 is a schematic diagram of an implementation environment of a virtual resource display method according to an embodiment of this disclosure.

FIG. 2 is a flowchart of a virtual resource display method according to an embodiment of this disclosure.

FIG. 3 is a flowchart of a virtual resource display method according to an embodiment of this disclosure.

FIG. 4 is a schematic diagram of a terminal interface according to an embodiment of this disclosure.

FIG. 5 is a schematic diagram of a terminal interface according to an embodiment of this disclosure.

FIG. 6 is a schematic diagram of a terminal interface according to an embodiment of this disclosure.

FIG. 7 is a schematic diagram of a terminal interface according to an embodiment of this disclosure.

FIG. 8 is a schematic diagram of a terminal interface according to an embodiment of this disclosure.

FIG. 9 is a schematic diagram of a terminal interface according to an embodiment of this disclosure.

FIG. 10 is a schematic diagram of a terminal interface according to an embodiment of this disclosure.

FIG. 11 is a schematic diagram of a terminal interface according to an embodiment of this disclosure.

FIG. 12 is a flowchart of a virtual resource display method according to an embodiment of this disclosure.

FIG. 13 is a schematic diagram of a terminal interface according to an embodiment of this disclosure.

FIG. 14 is a schematic diagram of a terminal interface according to an embodiment of this disclosure.

FIG. 15 is a schematic diagram of a terminal interface according to an embodiment of this disclosure.

FIG. 16 is a schematic structural diagram of a virtual resource display apparatus according to an embodiment of this disclosure.

FIG. 17 is a schematic structural diagram of a terminal 1700 according to an embodiment of this disclosure.

FIG. 18 is a schematic structural diagram of a server 1800 according to an embodiment of this disclosure.

### DESCRIPTION OF EMBODIMENTS

To make objectives, technical solutions, and advantages of this disclosure clearer, the following further describes exemplary implementations of this disclosure with reference to the accompanying drawings. The method may be applied to an electronic device. The electronic device may be either a server or a terminal device, or may be a combination of a terminal and an electronic device. The server may be a service device with a data processing capability located on a network side. The terminal may be a computing device such as a personal computer (PC) with a data processing capability located on a user side.

The terms “first”, “second”, and the like in this disclosure are used for distinguishing between same items or similar items of which effects and functions are basically the same. It should be understood that, the “first”, “second”, and “nth” do not have a dependency relationship in logic or time sequence, and a quantity and an execution order thereof are not limited.

In this disclosure, the term “at least one” means one or more, and “at least two” means two or more. For example, at least two node devices mean two or more node devices.

Terms involved in this disclosure are explained below.

A virtual scene can be displayed (or provided) by an application when run on a terminal. The virtual scene may be a simulated environment of a real world, may be a semi-simulated semi-fictional virtual environment, or may be an entirely fictional virtual environment. The virtual scene may include one of a two-dimensional virtual scene, a 2.5-dimensional virtual scene, or a three-dimensional virtual scene, and the dimension of the virtual scene is not limited in the embodiments of this disclosure. For example, the virtual scene may include the sky, the land, the ocean, or the like. The land may include environmental elements such as the desert and a city. The user may control the virtual object to move in the virtual scene.

A virtual object can include a movable object in a virtual scene. The movable object may be a virtual character, a virtual animal, a cartoon character, or the like, for example, a character, an animal, a plant, an oil drum, a wall, or a stone displayed in a virtual scene. The virtual object may be a virtual image used for representing a user in the virtual scene. The virtual scene may include a plurality of virtual objects, and each virtual object has a shape and a volume in the virtual scene, and occupies some space in the virtual scene.

The virtual object may be a player character controlled through an operation on a client, or may be an artificial intelligence (AI) character set in a virtual scene battle through training, or may be a non-player character (NPC) set in a virtual scene interaction. The virtual object may be a virtual character for competition in a virtual scene. A quantity of virtual objects participating in the interaction in the virtual scene may be preset, or may be dynamically determined according to a quantity of clients participating in the interaction.

For example, in a shooting game, a user may control the virtual object to descend freely, glide, parachute, or the like in the sky of the virtual scene, or run, jump, crawl, stoop to move forward, or the like on the land, or swim, float, dive, or the like in the ocean. The user may alternatively control the virtual object to drive a virtual vehicle to move in the virtual scene. For example, the virtual vehicle may be a virtual car, a virtual aircraft, or a virtual yacht. Herein, the foregoing scene is merely used as an example for description, which is not specifically limited in the embodiments of this disclosure. The user may alternatively control the virtual object to fight against or interact in other manners with another virtual object with a virtual resource. For example, the virtual resource may be a virtual weapon. The virtual weapon may be throwing virtual weapons such as grenades, cluster mines, smoke grenades, shock grenades, molotov cocktails, or sticky grenades (“sticky mines” for short), or may be shooting virtual weapons such as machine guns, pistols, or rifles. Types of the virtual weapons are exemplary and not specifically limited in this disclosure.

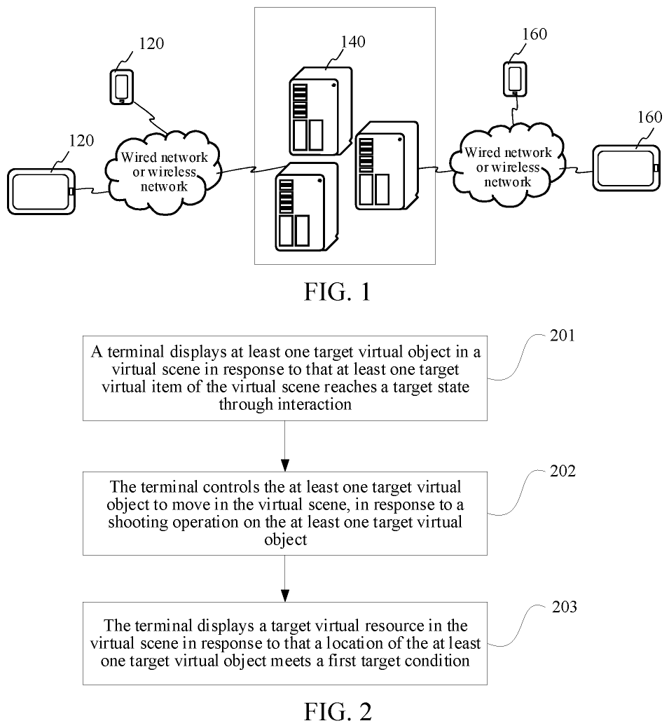

FIG. 1 is a schematic diagram of an implementation environment of a virtual resource display method according to an embodiment of this disclosure. Referring to FIG. 1, the implementation environment includes a first terminal 120, a server 140, and a second terminal 160.

An application supporting a virtual scene is installed and run on the first terminal 120. The application may be include one of a first-person shooting game (FPS) game, a third-person shooting game, a MOBA game, a virtual reality application, a three-dimensional map program, a military simulation program, or a multiplayer gunfight survival game. The first terminal 120 may be a terminal used by a first user, and the first user uses the first terminal 120 to operate a first virtual object in the virtual scene to perform a movement. The movement includes, but is not limited to, at least one of body posture adjustment, crawling, walking, running, cycling, jumping, driving, picking-up, shooting, attacking, and throwing. For example, the first virtual object is a first virtual character such as a simulated character role or a cartoon character role. For example, the first virtual object may be a first virtual animal such as a simulated monkey or another animal.

The first terminal 120 and the second terminal 160 are connected to the server 140 by using a wireless network or a wired network.

The server 140 may include at least one of one server, a plurality of servers, a cloud computing platform, and a virtualization center. The server 140 is configured to provide a backend service for an application supporting a virtual scene. The server 140 may be responsible for primary computing work, and the first terminal 120 and the second terminal 160 are responsible for secondary computing work. Alternatively, the server 140 is responsible for secondary computing work, and the first terminal 120 and the second terminal 160 are responsible for primary computing work. Alternatively, the server 140, the first terminal 120, and the second terminal 160 perform collaborative computing by using a distributed computing architecture among each other.

For example, the first terminal 120 and the second terminal 160 may transmit generated data to the server 140, and the server 140 may verify data generated by itself and the data generated by the terminals. If the data generated by the server is inconsistent with the data indicated by a verification result of any terminal, the data generated by the server may be transmitted to any terminal, and the data generated by the server prevails for any terminal.

An application supporting a virtual scene is installed and run on the second terminal 160. The application may include one of an FPS game, a third-person shooting game, a MOBA game, a virtual reality application, a three-dimensional map program, a military simulation program, or a multiplayer gunfight survival game. The second terminal 160 may be a terminal used by a second user, and the second user uses the second terminal 160 to operate a second virtual object in the virtual scene to perform a movement. The movement includes, but is not limited to, at least one of body posture adjustment, crawling, walking, running, cycling, jumping, driving, picking-up, shooting, attacking, and throwing. For example, the second virtual object is a second virtual character, such as a simulated character role or a cartoon character role. For example, the second virtual object may be a second virtual animal such as a simulated monkey or another animal.

In some embodiments, the first virtual object controlled by the first terminal 120 and the second virtual object controlled by the second terminal 160 are located in the same virtual scene, and in this case, the first virtual object may interact with the second virtual object in the virtual scene. In some embodiments, the first virtual object and the second virtual object may be in an opposing relationship. For example, the first virtual object and the second virtual object may belong to different teams and organizations. The virtual objects in the opposing relationship may interact with each other in the way of battle by shooting each other on the land.

In some other embodiments, the first virtual object and the second virtual object may be teammates, for example, the first virtual character and the second virtual character may belong to the same team or the same organization, and have a friend relationship with each other or have a temporary communication permission.

The applications installed on the first terminal 120 and the second terminal 160 are the same, or the applications installed on the two terminals are the same type of applications on different operating system platforms. The first terminal 120 may be generally one of a plurality of terminals, and the second terminal 160 may be generally one of a plurality of terminals. In this embodiment, only the first terminal 120 and the second terminal 160 are used for description. Device types of the first terminal 120 and the second terminal 160 are the same or different. The device type includes at least one of a smartphone, a tablet computer, an ebook reader, a moving picture experts group audio layer III (MP3) player, a moving picture experts group audio layer IV (MP4) player, and a laptop computer. For example, the first terminal 120 and the second terminal 160 may be smartphones, or other handheld portable game devices. The following embodiment is described by using an example in which the terminal includes a smartphone.

It should be understand that there may be more or fewer terminals. For example, there may be only one terminal, or there may be dozens of or hundreds of or more terminals. The number and the device type of the terminal are not limited in the embodiments of this disclosure.

FIG. 2 is a flowchart of a virtual resource display method according to an embodiment of this disclosure. Referring to FIG. 2, the method may include the following steps:

In step 201, terminal displays at least one target virtual object in a virtual scene in response to that at least one target virtual item of the virtual scene reaches a target state through interaction.

The target virtual item is a virtual item that can interact with a virtual object. In terms of virtual items, some virtual items such as shooting virtual items or casting virtual items can be used by the virtual object, and some virtual items can be triggered by the virtual object by shooting. The target virtual item may be used for providing a virtual resource. A user may cause, through one or more interaction manners, the target virtual item to reach a target state to obtain the virtual resource. For example, the user needs to control the virtual object to shoot the target virtual item to damage the target virtual item to trigger display of the virtual resource. The target virtual item may be further used for triggering display of at least one target virtual object. In this embodiment of this disclosure, a target state for triggering display of a target virtual object by a target virtual item may be preset. When the target virtual item reaches the target state through interaction, the at least one target virtual object is displayed in the virtual scene. For example, in a possible implementation, the target virtual item may correspond to one of an undamaged state or a damaged state. For example, when the target virtual item is an Easter egg, it may have an undamaged state and a damaged state.

The Easter egg is in an undamaged state when its appearance is not damaged, broken in its entirety, or the like. The Easter egg is in a damaged state when its appearance is damaged, or even the entire model of the Easter egg is broken or disappears, or the like. In this case, the target state may be the damaged state. When the user causes, through shooting or other interaction, the target virtual item to reach the damaged state, display of at least one target virtual object can be triggered. The at least one target virtual object is used for triggering display of the target virtual resource.

There may be various interaction manners and various target states. For example, in addition to the foregoing manner of causing the target virtual item to be in the damaged state through shooting or other attack manners, the user may control a controlled virtual object to approach the target virtual item and perform various non-attack interaction operations on the target virtual item, such as picking up the target virtual item, to cause the target virtual object to reach the target state.

The user may perform an operation on the terminal to control the controlled virtual object to use a shooting virtual item or a casting virtual item to attack the target virtual item in the virtual scene.

In a possible implementation, durability may be set for the target virtual item. When the durability of the target virtual item drops to zero, it may be determined that the target virtual item reaches the target state through interaction.

In a possible implementation, the target virtual item may be a movable virtual item. For example, the target virtual item can move within a location range. For example, the target virtual item may be a jumping egg. The jumping egg may be an egg that can jump in the virtual scene. The user can control the controlled virtual object to shoot the jumping egg to cause the jumping egg to reach the target state.

In step 202, the terminal controls the at least one target virtual object to move in the virtual scene, in response to a shooting operation on the at least one target virtual object.

After the terminal displays the at least one target virtual object, the at least one target virtual object can move in the virtual scene when being shot. If the at least one virtual object is not shot, the at least one target virtual object may remain in a stationary state. When a shooting operation on the at least one target virtual object is detected, the at least one target virtual object may be controlled to move in the virtual scene.

In step 203, the terminal displays a target virtual resource in the virtual scene in response to that a location of the at least one target virtual object meets a first target condition.

In this embodiment of this disclosure, the first target condition is set for the location of the at least one target virtual object. The first target condition is a display trigger condition for the target virtual resource. Shooting the at least one target virtual object to make the at least one target virtual object move to change the location of the at least one target virtual object, so that the first target condition is met, and the display of the target virtual resource is triggered accordingly. This, compared with the manner of displaying a target virtual object in a virtual scene at the beginning of a competition, can effectively guide users to operate. The display manner of triggering the display of the target virtual resource through user operations is more interesting and novel, thereby effectively making a virtual resource display manner more interesting and providing a better virtual resource display effect.

In this embodiment of this disclosure, at least one target virtual object is displayed in a virtual scene when at least one target virtual item of the virtual scene reaches a target state through interaction. This provides a flexible and highly interesting display trigger manner for the at least one target virtual object. Subsequently, the at least one target virtual object can be controlled to move in the virtual scene by shooting the at least one target virtual object. Such a novel control manner of causing a target virtual object to move through a shooting operation instead of directly controlling actions of the target virtual object can be much more interesting. In addition, a target virtual resource can be displayed when a location of the at least one target virtual object meets a first target condition. This provides a novel virtual resource display triggering manner. The target virtual resource needs to be triggered by the foregoing operation for display, instead of being directly displayed in the virtual scene at the beginning of a competition. Therefore, the trigger manner is novel and can motivate users to operate, thereby effectively making a virtual resource display manner more interesting and providing a better virtual resource display effect.

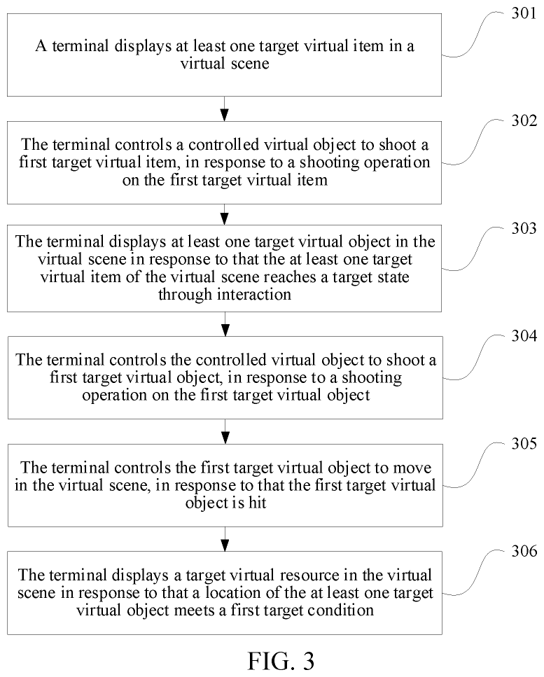

FIG. 3 is a flowchart of a virtual resource display method according to an embodiment of this disclosure. Referring to FIG. 3, the method may include the following steps:

In step 301, a terminal displays at least one target virtual item in a virtual scene.

The at least one target virtual item may be displayed in the virtual scene at the beginning of a competition, or may be obtained through calling by a virtual object. For example, there are the following two cases. The at least one target virtual item includes a first target virtual item.

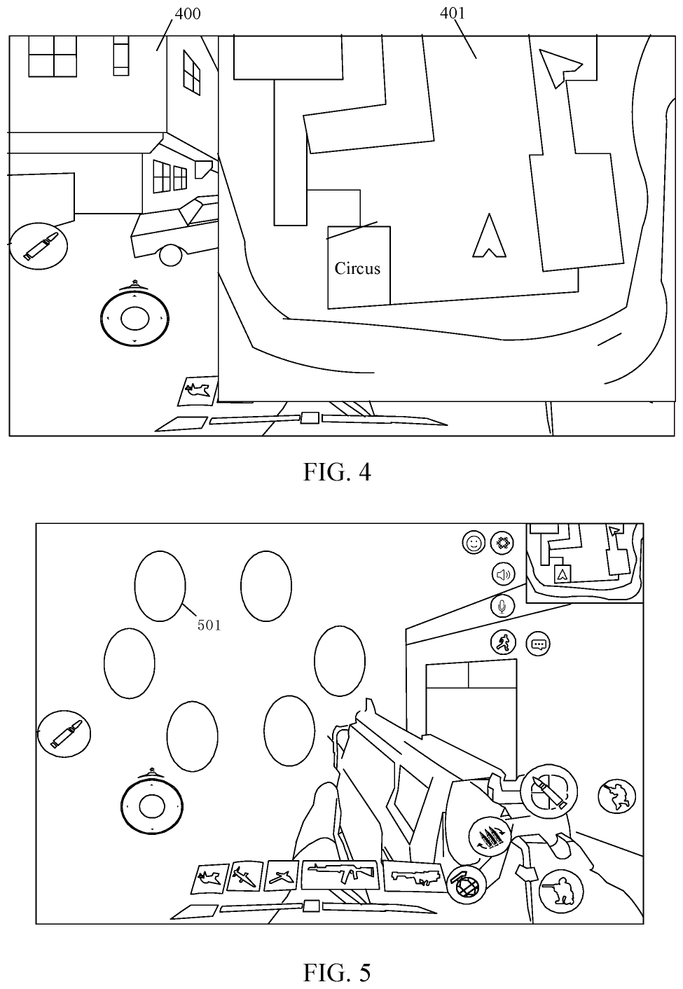

In case 1, the target virtual item may be displayed on the ground or a virtual article of the virtual scene. In a possible implementation, the at least one target virtual item may be at a specific location in the virtual scene. For example, the at least one target virtual item may be at least one jumping egg. The at least one jumping egg may be located in a “circus” in the virtual scene. The “circus” is a location in the virtual scene. As shown in FIG. 4, in a user graphic interface 400, a location of the circus may be viewed through a mini-map 401. As shown in FIG. 5, a user controls a controlled virtual object to reach the location of the circus and enter a building of the circus, and a plurality of jumping eggs 501 are displayed in a region of the building. In a possible implementation, the target virtual item is a movable virtual item. The terminal may display that the at least one target virtual item moves in the virtual scene. For example, as shown in FIG. 5, the terminal may display the plurality of jumping eggs 501 in a region of the building. The plurality of jumping eggs 501 jump up and down in the region.

In case 2, the at least one target virtual item is obtained through calling by the virtual object. The terminal may display a call control in the virtual scene. When the user intends to call the target virtual item, the user may perform a trigger operation on the call control. In this case, the terminal receives a trigger signal for the call control and generates a create instruction, so that the target virtual item can be created in response to the create instruction. The call control is used for calling the target virtual item to enter the virtual scene. The call control may be in a form of a button displayed in a floating manner in the virtual scene.

In step 302, the terminal controls a controlled virtual object to shoot a first target virtual item, in response to a shooting operation on the first target virtual item.

After the terminal displays the at least one target virtual item, the user may perform a shooting operation to attack any target virtual item, for example, the first target virtual item, to obtain a virtual resource corresponding to the first target virtual item. In response to detection of the shooting operation, the terminal can control the controlled virtual object to shoot the first target virtual item.

In a possible implementation, durability may be set for the first target virtual item. The terminal controls the controlled virtual object to shoot the first target virtual item. If the first target virtual item is hit, the durability of the first target virtual item is reduced. When the durability becomes 0, the terminal may determine that the first target virtual item reaches the target state through interaction.

In step 303, the terminal displays at least one target virtual object in the virtual scene in response to that the at least one target virtual item of the virtual scene reaches a target state through interaction.

Through step 302, the terminal controls the controlled virtual object to shoot the at least one target virtual item. If durability of the at least one target virtual item drops to zero, it may be considered that the at least one target virtual item reaches the target state through interaction. The user may control the controlled virtual object to shoot target virtual items one by one. When all the target virtual items reach the target state through interaction, display of the at least one target virtual object in the virtual scene can be triggered. In addition, alternatively, the at least one target virtual object may be displayed without the need to shoot all target virtual items, but only a specified number of target virtual items need to be caused to reach the target state through interaction.

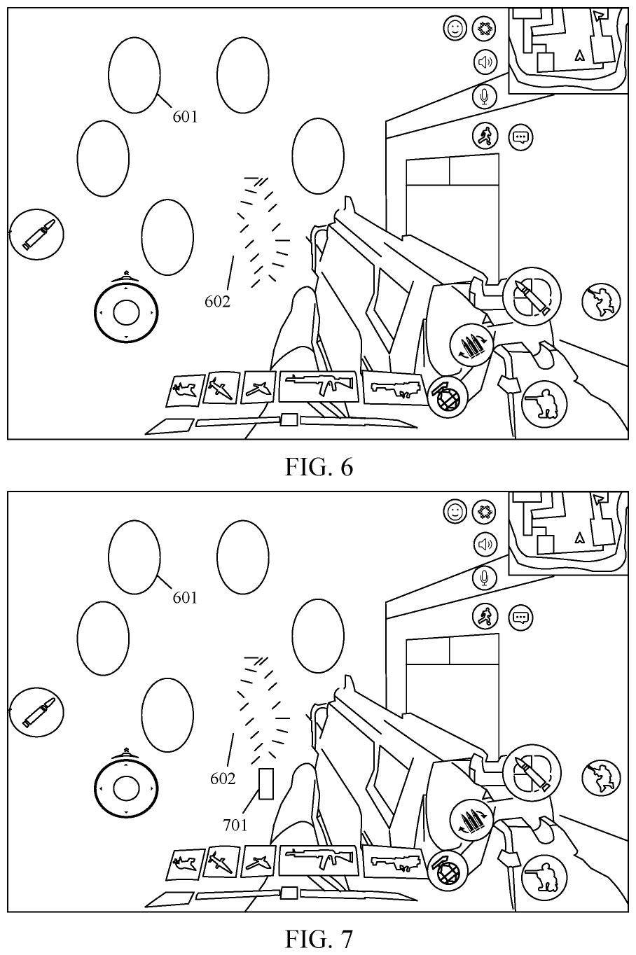

In a possible implementation, when the target virtual item reaches the target state through interaction, an effect of the target virtual item reaching the target state can be reflected through an animation, to achieve a function of prompting and improve user perception. Specifically, the at least one target virtual item may include a first target virtual item. The terminal may display a target animation in response to that the first target virtual item reaches the target state through interaction. The target animation is used for indicating that the first target virtual item reaches the target state. For example, the target animation may be a deformation animation, through which a process of deformation of the first target virtual item is represented, or the target animation may be a special effect animation, such as an explosion effect animation. As shown in FIG. 6, the user attacks a target virtual item 601. When the target virtual item reaches the target state through interaction, an explosion effect animation 602 is displayed, to represent an explosion effect of the target virtual item 601.

In a possible implementation, when the target virtual item reaches the target state through interaction, a virtual resource corresponding to the target virtual item can be dropped. Specifically, the at least one target virtual item may include a first target virtual item. The terminal displays a virtual resource corresponding to the target virtual item at a location corresponding to the first target virtual item in the virtual scene in response to that the first target virtual item reaches the target state through interaction. Obtaining a corresponding virtual resource by attacking a target virtual item provides a virtual resource provision manner, motivates a user to operate, and improves interactivity between the user and a virtual item, thereby making a virtual resource obtaining process more interesting. For example, as shown in FIG. 7, the user attacks a jumping egg, so that after the jumping egg explodes, a virtual resource 701 can be dropped therefrom onto the ground. It can be understood that, in addition to being dropped from the target virtual item, the virtual resource may appear in other manners, which are not limited herein.

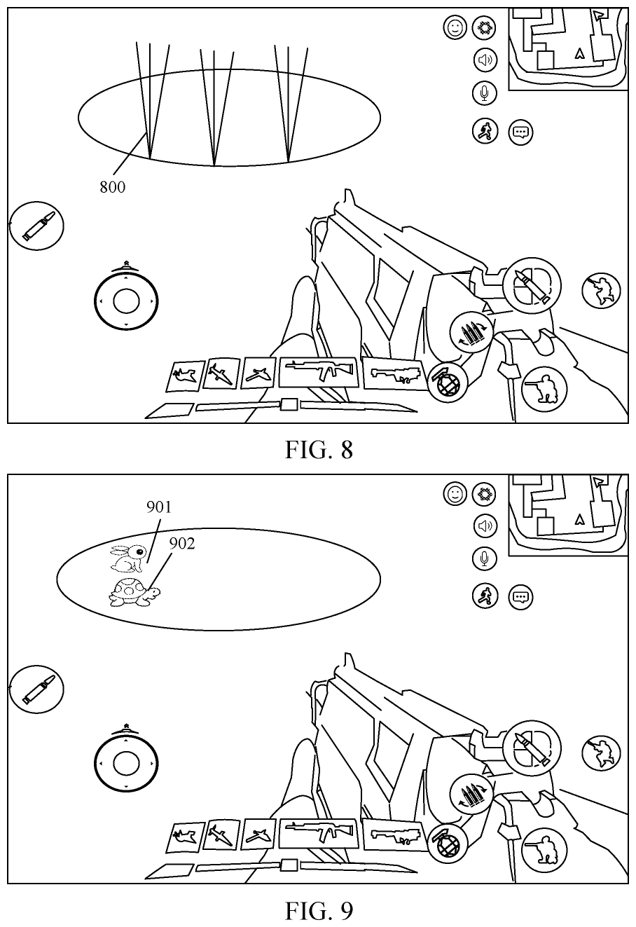

In a possible implementation, the terminal may further display a special effect corresponding to the at least one target virtual object in the virtual scene. The special effect is used for identifying a target region in which the at least one target virtual object is located. The user is prompted, through the special effect, with a target virtual object that appears in the target region. In this way, the user spontaneously finds the target virtual object without any other prompt, and then finds how to trigger display of the target virtual resource. For example, as shown in FIG. 8, a special effect 800 may be displayed in a display region of the target virtual object.

Step 302 and step 303 described above are a process of performing the step of displaying at least one target virtual object in the virtual scene in response to that durability of the at least one target virtual item of the virtual scene drops to zero. The user may control the controlled virtual object to attack the at least one target virtual item. The number of the at least one target virtual item may be one or multiple. If there are a plurality of target virtual items, when all the plurality of target virtual items reach the target state through interaction, at least one target virtual object can be displayed. The number of the at least one target virtual object may be one or multiple. The numbers of target virtual items and target virtual objects are not limited in the embodiments of this disclosure.

In step 304, the terminal controls the controlled virtual object to shoot a first target virtual object, in response to a shooting operation on the first target virtual object.

The at least one target virtual object is used for providing a target virtual resource. The user needs to shoot the target virtual object to drive the target virtual object to move. For example, the user may shoot the first target virtual object included in the at least one target virtual object.

The user may perform a viewing angle adjustment operation. After detecting the viewing angle adjustment operation, the terminal may determine a target rotation angle of a viewing angle according to the viewing angle adjustment operation, to control the viewing angle of the virtual scene to rotate by the target rotation angle. Through the viewing angle adjustment operation, the user can adjust an aiming location, and can perform a shooting operation after the aiming location is determined. The user can aim at the first target virtual object through the viewing angle adjustment operation, and then shoot the first target virtual object through the shooting operation.

In step 305, the terminal controls the first target virtual object to move in the virtual scene, in response to that the first target virtual object is hit.

If the first target virtual object is hit, the first target virtual object can move in the virtual scene. If the first target virtual object is not hit, the first target virtual object remains stationary in place.

In a possible implementation, the terminal controls the first target virtual object to move in the virtual scene by a target distance, in response to that the first target virtual object is hit once. In this way, the user can continue to maintain the shooting operation. After detecting the shooting operation, the terminal can control the first target virtual object to keep moving to adjust a location of the first target virtual object, until the shooting operation is stopped. Through the setting of the target distance, an accurate movement operation manner can be provided for the user, and the first target virtual object can be accurately moved to a location required by the user.

The target distance may be set by a related technical person according to requirements. This is not limited in the embodiments of this disclosure.

Step 304 and step 305 above are described only by using the first target virtual object as an example. The manner may be a process of controlling the at least one target virtual object to move in the virtual scene, in response to a shooting operation on the at least one target virtual object. The process may alternatively be another manner. For example, a target movement speed may be set for movement of the first target virtual object in the process. The target movement speed may be determined with the number of hits of the first target virtual object. For example, the target movement speed may be positively correlated with the number of hits. A specific implementation is not limited in this embodiment of this disclosure.

In step 306, the terminal displays a target virtual resource in the virtual scene in response to that a location of the at least one target virtual object meets a first target condition.

In this embodiment of this disclosure, a trigger condition may be set for the display of the target virtual resource. This, compared with the manner of displaying a virtual resource in a virtual scene at the beginning of a competition in the related art, provides a flexible and highly interesting display trigger manner. The manner of shooting a target virtual object to control its movement can be much more interesting, improving interaction between a user and a virtual item, and can motivate the user to operate, thereby effectively making a virtual resource display manner more interesting and providing a better virtual resource display effect.

In a possible implementation, two target virtual objects may be set. Specifically, the at least one target virtual object includes a first target virtual object and a second target virtual object. For example, as shown in FIG. 9, the first target virtual object may be a virtual hare 901, and the second target virtual object may be a virtual tortoise 902.

Correspondingly, the first target condition may be that the first target virtual object reaches a first target location and the second target virtual object reaches a second target location. In other words, in step 306, the terminal may display the target virtual resource in the virtual scene in response to that the first target virtual object reaches the first target location and the second target virtual object reaches the second target location.

The first target location and the second target location may be set by a related technical person according to requirements. The first target location and the second target location may be the same or different, which is not limited in this embodiment of this disclosure.

The foregoing setting of the first target location and the second target location allows user operations to be more complex and more interesting, thereby providing a flexible and novel virtual resource obtaining manner, making display of virtual resources more interesting, and providing a better virtual resource display effect.

In a possible implementation, an arrival time sequence may alternatively be set for the locations of the two target virtual objects. When the arrival time sequence also meets a condition, the display of the target virtual resource can be triggered. Specifically, the terminal may display the target virtual resource in the virtual scene in response to that the first target virtual object reaches the first target location and the second target virtual object reaches the second target location, and that a moment at which the first target virtual object reaches the first target location is earlier than a moment at which the second target virtual object reaches the second target location. In other words, a first time at which the first target virtual object reaches the first target location is before a second time at which the second target virtual object reaches the second target location.

In step 303, the at least one target virtual object is displayed at an initial display location. If a location of the at least one target virtual object does not meet a first target condition but meets a second target condition, the at least one target virtual object may be displayed at the initial display location and the target virtual resource is not displayed, to instruct a player to control the at least one target virtual object again to move to obtain the target virtual resource. In other words, in step 303, the terminal may display the at least one target virtual object at the initial display location of the at least one target virtual object in the virtual scene in response to that the at least one target virtual item of the virtual scene reaches the target state through interaction. Through step 304, the terminal may display the at least one target virtual object at the initial display location and does not display the target virtual resource in response to that the location of the at least one target virtual object meets the second target condition. The terminal may display an action of the at least one target virtual object returning to the initial display location, or may directly display the target virtual object at the initial display location and omit an action of returning to the location, to further increase the display speed.

In the implementation in which the at least one target virtual object includes the first target virtual object and the second target virtual object, the second target condition may be that the first target virtual object does not reach the first target location while the second target virtual object reaches the second target location. For example, the terminal may display the at least one target virtual object at the initial display location in response to that the first target virtual object does not reach the first target location while the second target virtual object reaches the second target location. Through the foregoing setting, movement rules are set for the two target virtual objects and a trigger condition is set for the display of the target virtual resource, thereby making user operations more complex, motivating users to operate, and making the process more interesting.

In some embodiments, during the display of the target virtual resource, the terminal may cancel the display of the first target virtual object and the second target virtual object.

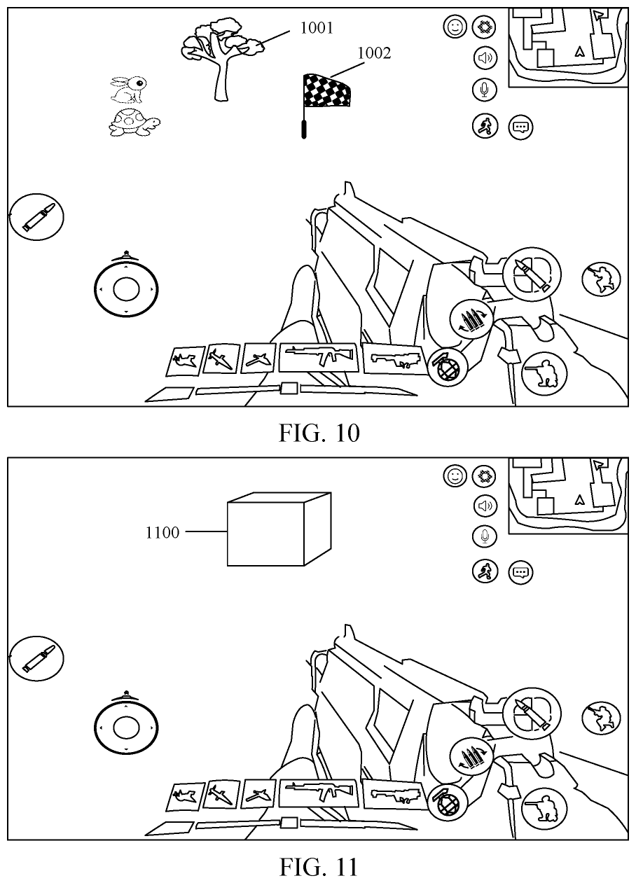

For example, in a specific example, the first target virtual object may be a virtual hare, and the second target virtual object may be a virtual tortoise. As shown in FIG. 10, the terminal may display a virtual tree 1001 at the first target location and display a race finish flag 1002 at the second target location. If the user controls the virtual hare to reach the virtual tree first and then controls the virtual tortoise to reach the finish, the display of the target virtual resource may be triggered. A target virtual resource 1100 may be shown in FIG. 11. The virtual tortoise and the virtual hare disappear. If the user does not control the virtual hare to reach the virtual tree while controlling the virtual tortoise to reach the finish first, the terminal may control the virtual hare and the virtual tortoise to return to the start.

After the terminal displays the target virtual resource, the user may control the controlled virtual object to approach the target virtual resource to pick up the target virtual resource. For example, when a distance between the controlled virtual object corresponding to the terminal and the target virtual resource is less than a target threshold, a pickup option for the target virtual resource is displayed in the virtual scene. When detecting a trigger operation for the pickup option, the terminal may control the controlled virtual object to pick up the target virtual resource. After the pickup is completed, the target virtual resource may be displayed at a target part of the controlled virtual object in the virtual scene, representing that the controlled virtual object is equipped with the target virtual resource.

The target virtual resource may be a more advanced resource compared with other virtual resources, for example, equipment with more power. Obtained advanced equipment through complex operations can provide users with a more interesting obtaining manner, thereby making a virtual resource display manner more interesting.

In some embodiments, the foregoing virtual resource display method may be provided in a competitive mode, and in other competitive modes, virtual resources may be displayed in other manners. The terminal may perform the foregoing step in response to that a current competitive mode is a target competitive mode, to implement the display of the virtual resource. For example, the target competitive mode is a campaign mode.

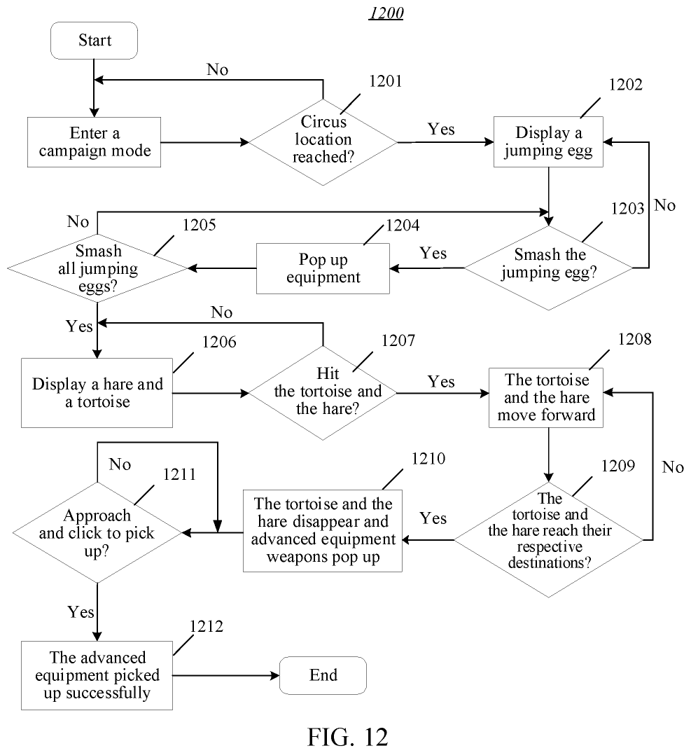

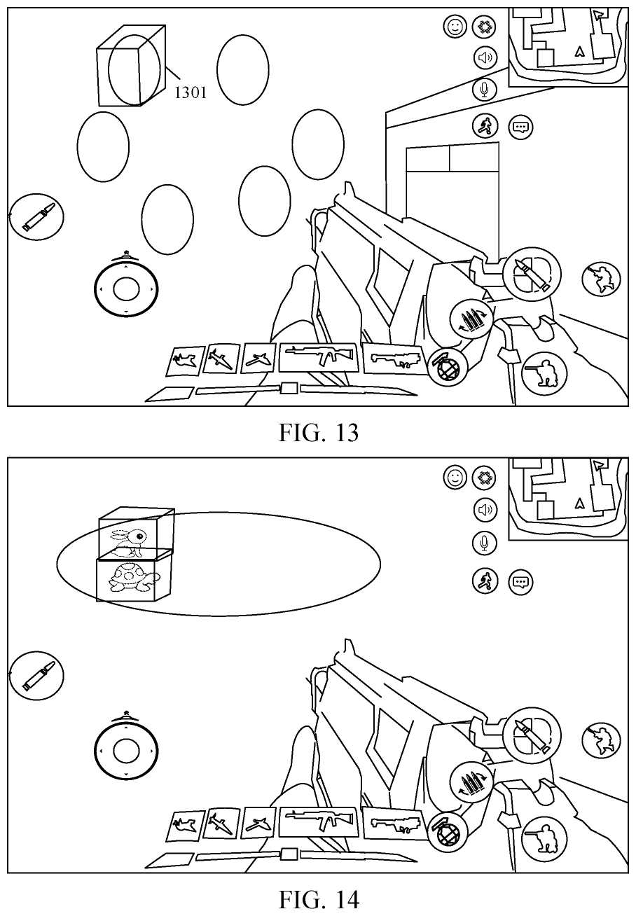

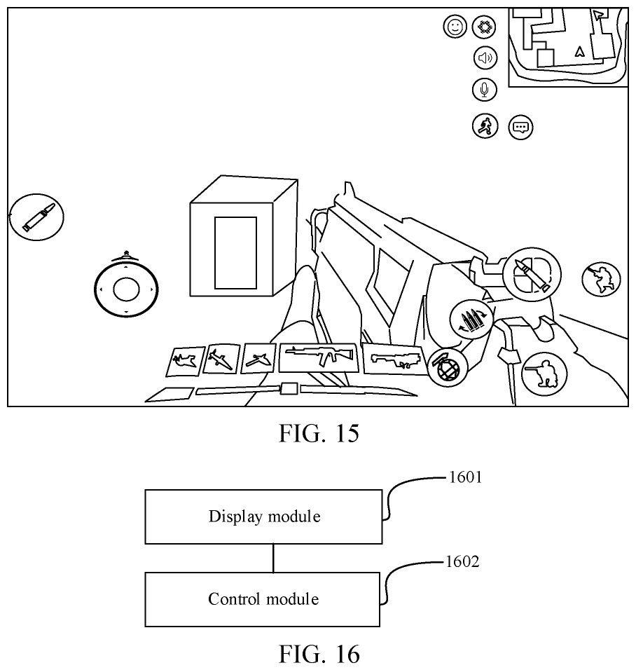

The following provides a specific example. As shown in FIG. 12, in a procedure 1200 of the method, the terminal enters the campaign mode at the beginning of the competition. The terminal performs step 1201 of determining whether a circus location is reached, and if yes, the terminal may perform step 1202 of displaying a jumping egg; or if no, the terminal returns to the initial state to continue detection. In the specific example, the target state may be a smashed state and the interaction may be a shooting action. A player starts to use a weapon to damage a jumping egg in a place full of jumping eggs. The jumping egg is actually similar to a character model, with a damage detection box hanging on the body. In this way, when the player uses the weapon to fire a bullet, the bullet can detect a physical collision box on the body, and then damage can be calculated like attacking an enemy. The physical collision box 1301 may be shown in FIG. 13. The terminal may perform step 1203 of determining whether to smash the jumping egg, and if yes, step 1204 of popping up equipment (from the jumping egg) is performed; or if no, the jumping egg continues to be displayed. After using the weapon to smash all the jumping eggs, the player may enter a race between the tortoise and the hare in the next step. Similarly, the tortoise and the hare are each a model with a rectangular collision detection box hanging thereon, as shown in FIG. 14. However, there is no need to calculate damage for the tortoise or the hare, because the tortoise and the hare cannot be damaged as they move forward when attacked. However, the tortoise is not to be allowed to reach the flag first; otherwise, the race is to start over. Instead, the hare is required to reach the location of the tree first, and then the tortoise is allowed to reach the location of the flag. In this way, the race succeeds. For example, the terminal performs step 1205 of determining whether to smash all jumping eggs, and if yes, the terminal performs step 1206 of displaying the hare and the tortoise, or if no, the terminal continues the detection. The terminal performs step 1207 of determining whether to hit the tortoise and the hare, and if yes, the terminal performs step 1208 of controlling the tortoise and the hare to move forward, or if no, the terminal continues to display the hare and the tortoise. The terminal performs step 1209 of determining whether the tortoise and the hare reach their respective destinations, and if yes, the terminal performs step 1210 of making the tortoise and the hare disappear and popping up advanced equipment weapons, or if no, the terminal continues the detection. After a task is successfully completed, advanced equipment pops up, and the player can pick up the advanced equipment when the player approaches the advanced equipment. All equipment is equipped with a collision detection box thereon. A character model is also equipped with a collision detection box thereon. Pickup logic is triggered after the collision detection box on the character model comes in contact with the collision detection box on the equipment. As shown in FIG. 15, there are collision detection boxes around the equipment. When the character model approaches, display of a pickup menu can be triggered. Specifically, the terminal performs step 1211 of determining whether to approach and click to pick up, and if yes, the terminal performs step 1212 of picking up the advanced equipment successfully, or if no, the terminal continues the detection.

In this embodiment of this disclosure, at least one target virtual object is displayed in a virtual scene when at least one target virtual item of the virtual scene reaches a target state through interaction. This provides a flexible and highly interesting display trigger manner for the at least one target virtual object. Subsequently, the at least one target virtual object can be controlled to move in the virtual scene by shooting the at least one target virtual object. Such a novel control manner of causing a target virtual object to move through a shooting operation instead of directly controlling actions of the target virtual object can be much more interesting. In addition, a target virtual resource can be displayed when a location of the at least one target virtual object meets a first target condition. This provides a novel virtual resource display triggering manner. The target virtual resource needs to be triggered by the foregoing operation for display, instead of being directly displayed in the virtual scene at the beginning of a competition. Therefore, the trigger manner is novel and can motivate users to operate, thereby effectively making a virtual resource display manner more interesting and providing a better virtual resource display effect.

Any of the foregoing technical solutions may be combined in different manners to form other embodiments of this disclosure, and details are not described herein again.

FIG. 16 is a schematic structural diagram of a virtual resource display apparatus according to an embodiment of this disclosure. Referring to FIG. 16, the apparatus includes a display module 1601 and a control module 1602. One or more modules, submodules, and/or units of the apparatus can be implemented by processing circuitry, software, or a combination thereof, for example.

The display module 1601 is configured to display at least one target virtual object in a virtual scene in response to that at least one target virtual item of the virtual scene reaches a target state through interaction.

The control module 1602 is configured to control the at least one target virtual object to move in the virtual scene, in response to a shooting operation on the at least one target virtual object.

The display module 1601 is further configured to display a target virtual resource in the virtual scene in response to that a location of the at least one target virtual object meets a first target condition.

In a possible implementation, the at least one target virtual object includes a first target virtual object, and the control module 1602 is configured to: control a controlled virtual object to shoot the first target virtual object, in response to a shooting operation on the first target virtual object; and control the first target virtual object to move in the virtual scene, in response to that the first target virtual object is hit.

In a possible implementation, the control module 1602 is configured to control the first target virtual object to move in the virtual scene by a target distance, in response to that the first target virtual object is hit once.

In a possible implementation, the at least one target virtual object includes a first target virtual object and a second target virtual object. The display module 1601 is configured to display the target virtual resource in the virtual scene in response to that the first target virtual object reaches a first target location and the second target virtual object reaches a second target location.

In a possible implementation, the display module 1601 is configured to display the target virtual resource in the virtual scene in response to that the first target virtual object reaches the first target location and the second target virtual object reaches the second target location, and that a moment at which the first target virtual object reaches the first target location is earlier than a moment at which the second target virtual object reaches the second target location.

In a possible implementation, the display module 1601 is configured to display the at least one target virtual object at an initial display location of the at least one target virtual object in the virtual scene in response to that the at least one target virtual item of the virtual scene reaches the target state through interaction.

In a possible implementation, the display module 1601 is configured to display the at least one target virtual object at the initial display location and skip displaying the target virtual resource, in response to that the location of the at least one target virtual object meets a second target condition.

In a possible implementation, the at least one target virtual object includes a first target virtual object and a second target virtual object. The display module 1601 is configured to display the at least one target virtual object at the initial display location, in response to that the first target virtual object does not reach a first target location while the second target virtual object reaches a second target location.

In a possible implementation, the at least one target virtual item includes a first target virtual item, and the display module 1601 is further configured to display the first target virtual item in the virtual scene. The control module 1602 is configured to control a controlled virtual object to shoot the first target virtual item, in response to a shooting operation on the first target virtual item.

In a possible implementation, the display module 1601 is further configured to determine that the at least one target virtual item reaches the target state through interaction, in response to that durability of the at least one target virtual item of the virtual scene drops to zero. In a possible implementation, the display module 1601 is further configured to display a special effect corresponding to the at least one target virtual object in the virtual scene, the special effect being used for identifying a target region in which the at least one target virtual object is located.

In a possible implementation, the at least one target virtual item includes a first target virtual item, and the display module 1601 is further configured to display a target animation in response to that the first target virtual item reaches the target state through interaction, the target animation being used for indicating that the first target virtual item reaches the target state.

In a possible implementation, the at least one target virtual item includes a first target virtual item, and the display module 1601 is further configured to display a virtual resource corresponding to the first target virtual item at a location corresponding to the first target virtual item in the virtual scene in response to that the first target virtual item reaches the target state through interaction.

The division of the above functional modules is only described for exemplary purposes when the virtual resource display apparatus provided in the foregoing embodiment displays a virtual resource. In actual application, the functions may be allocated to different functional modules according to specific needs, which means that the internal structure of the electronic device is divided into different functional modules to complete all or some of the above described functions. In addition, the virtual resource display apparatus provided in the foregoing embodiment belongs to the same concept as the virtual resource display method embodiment. For a specific implementation process of the apparatus, refer to the virtual resource display method embodiment. Details are not described herein again.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

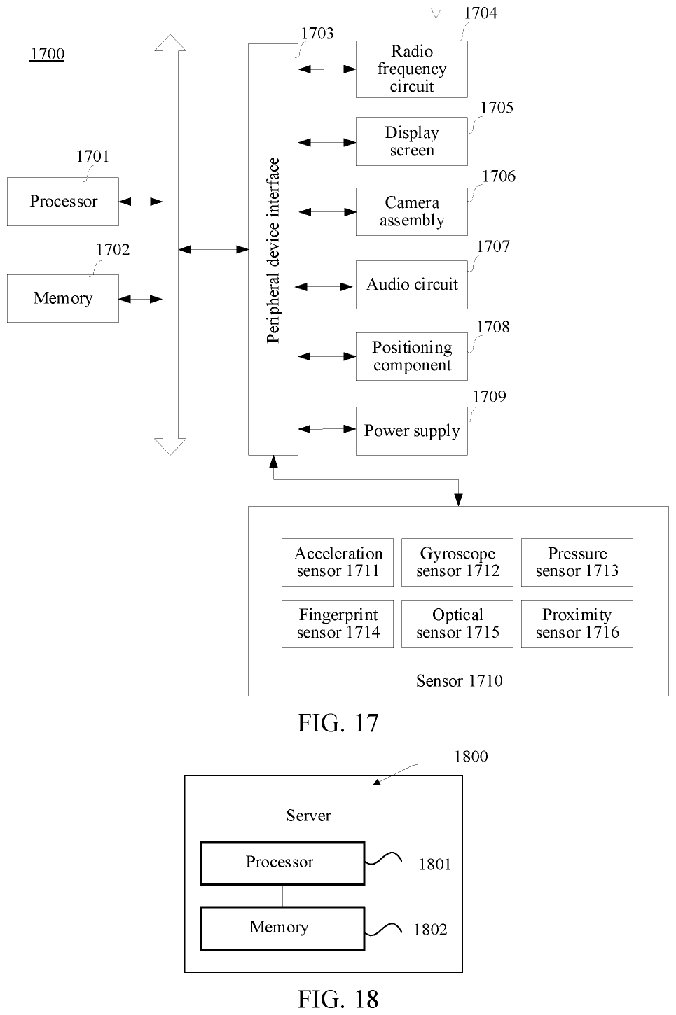

The electronic device may be provided as a terminal shown in FIG. 17, or may be provided as a server shown in FIG. 18. This is not limited in this embodiment of this disclosure.

FIG. 17 is a schematic structural diagram of a terminal 1700 according to an embodiment of this disclosure. The terminal 1700 may be a smartphone, a tablet computer, an MP3 player, an MP4 player, a notebook computer, or a desktop computer. The terminal 1700 may also be referred to as user equipment, a portable terminal, a laptop terminal, or a desktop terminal, among other names.

Generally, the terminal 1700 includes processing circuitry, such as a processor 1701, and a memory 1702. In some embodiments, the terminal 1700 may include a peripheral device interface 1703 and at least one peripheral device. For example, the peripheral device includes at least one of a radio frequency circuit 1704, a touch display screen 1705, a camera assembly 1706, an audio circuit 1707, a positioning component 1708, or a power supply 1709.

In some embodiments, the terminal 1700 also includes one or more sensors 1710. The one or more sensors 1710 include, but are not limited to: an acceleration sensor 1711, a gyroscope sensor 1712, a pressure sensor 1713, a fingerprint sensor 1714, an optical sensor 1715, and a proximity sensor 1716.

It will be appreciated by those skilled in the art that the structure shown in FIG. 17 does not constitute any limitation on the terminal 1700 and may include more or fewer assemblies than illustrated, or some assemblies may be combined, or different assembly arrangements may be employed.

FIG. 18 is a schematic structural diagram of a server 1800 according to an embodiment of this disclosure. The server 1800 may vary greatly due to different configurations or performance, and may include processing circuitry, such as one or more processors (central processing unit, CPU) 1801, and one or more memories 1802. The memory 1802 stores at least one piece of program code, the at least one piece of program code being loaded and executed by the processor 1801 to implement the method steps on the server side of the virtual resource display methods provided in the foregoing embodiments. The server 1800 may also have a wired or wireless network interface, a keyboard, an input/output interface and other components to facilitate input/output. The server 1800 may also include other components for implementing device functions. Details are not described herein.

In an exemplary embodiment, a storage medium is further provided. The storage medium may be a computer-readable storage medium, such as a non-transitory computer-readable storage medium. The storage medium is configured to store a computer program. The computer program is used for performing the virtual resource display method in any one of the foregoing embodiment. For example, the storage medium may be a memory that includes at least one piece of program code. The at least one piece of program code may be executed by a processor in an electronic device to complete the virtual resource display method in the foregoing embodiment. For example, the computer-readable storage medium may be a read-only memory (ROM), a random access memory (RAM), a compact disc read-only memory (CD-ROM), a magnetic tape, a floppy disk, an optical data storage device, or the like.

In an exemplary embodiment, a computer program product or a computer program that includes instructions is provided, including one or more pieces of program code, the one or more pieces of program code being stored in a computer-readable storage medium. One or more processors of a computer device can read the one or more pieces of program code from the computer-readable storage medium. The one or more processors execute the one or more pieces of program code. The computer program product, when run on a computer, can enable the computer to perform the foregoing virtual resource display method.

Persons of ordinary skill in the art may understand that all or some of the steps of the foregoing embodiments may be implemented by using hardware, or may be implemented by a program instructing relevant hardware. The program may be stored in a computer-readable storage medium. The above-mentioned storage medium may be a read-only memory, a magnetic disk, an optical disc, or the like.

The foregoing descriptions are merely exemplary embodiments of this disclosure, but are not intended to limit this disclosure. Other embodiments shall fall within the scope of this disclosure.

What is claimed is:

1. A virtual resource display method, comprising:
displaying at least one target virtual object in a virtual scene in response to at least one target virtual item of the virtual scene reaching a target state through user interaction;
controlling the at least one target virtual object to move in the virtual scene in response to a shooting operation on the at least one target virtual object; and
displaying, by processing circuitry, a target virtual resource in the virtual scene in response to a location of the at least one target virtual object meeting a first target condition.

2. The method according to claim 1, wherein
the at least one target virtual object includes a first target virtual object, and
the controlling the at least one target virtual object includes:
controlling a user-controlled virtual object to shoot the first target virtual object in response to the shooting operation on the first target virtual object; and
controlling the first target virtual object to move in the virtual scene in response to the first target virtual object being hit by the shooting operation.

3. The method according to claim 2, wherein the controlling the first target virtual object comprises:
controlling the first target virtual object to move in the virtual scene by a target distance in response to the first target virtual object being hit once by the shooting operation.

4. The method according to claim 1, wherein
the at least one target virtual object includes a first target virtual object and a second target virtual object; and
the displaying the target virtual resource in the virtual scene includes displaying the target virtual resource in the virtual scene in response to the first target virtual object reaching a first target location and the second target virtual object reaching a second target location.

5. The method according to claim 4, wherein the displaying the target virtual resource in the virtual scene in response to the first target virtual object reaching the first target location and the second target virtual object reaching the second target location comprises:
displaying the target virtual resource in the virtual scene in response to the first target virtual object reaching the first target location before the second target virtual object reaches the second target location.

6. The method according to claim 1, wherein
the displaying the at least one target virtual object in the virtual scene includes displaying the at least one target virtual object at an initial display location of the at least one target virtual object in the virtual scene in response to the at least one target virtual item of the virtual scene reaching the target state; and
the method further includes displaying the at least one target virtual object at the initial display location without display of the target virtual resource in response to the location of the at least one target virtual object meeting a second target condition.

7. The method according to claim 6, wherein
the at least one target virtual object includes a first target virtual object and a second target virtual object; and
the displaying the at least one target virtual object at the initial display location without the display of the target virtual resource includes displaying the at least one target virtual object at the initial display location without the display of the target virtual resource in response to the first target virtual object not reaching a first target location when the second target virtual object reaches a second target location.

8. The method according to claim 1, wherein
the at least one target virtual item includes a first target virtual item, and
before the displaying the at least one target virtual object, the method further includes:
displaying the first target virtual item in the virtual scene; and
controlling a user-controlled virtual object to shoot the first target virtual item in response to the shooting operation on the first target virtual item.

9. The method according to claim 1, further comprising:
determining that the at least one target virtual item reaches the target state in response to durability of the at least one target virtual item of the virtual scene reaching zero based on a shooting operation on the at least one target virtual item.

10. The method according to claim 1, further comprising:
displaying a special effect corresponding to the at least one target virtual object in the virtual scene, the special effect identifying a target region in which the at least one target virtual object is located.

11. The method according to claim 1, wherein
the at least one target virtual item includes a first target virtual item, and
the method further includes displaying a target animation in response to the first target virtual item reaching the target state, the target animation indicating that the first target virtual item reaches the target state.

12. The method according to claim 1, wherein
the at least one target virtual item includes a first target virtual item, and
the method further includes displaying the target virtual resource corresponding to the first target virtual item at the location corresponding to the first target virtual item in the virtual scene in response to the first target virtual item reaching the target state.

13. A virtual resource display apparatus, comprising:
processing circuitry configured to:
display at least one target virtual object in a virtual scene in response to at least one target virtual item of the virtual scene reaching a target state through user interaction;
control the at least one target virtual object to move in the virtual scene in response to a shooting operation on the at least one target virtual object; and
display a target virtual resource in the virtual scene in response to a location of the at least one target virtual object meeting a first target condition.

14. The virtual resource display apparatus according to claim 13, wherein
the at least one target virtual object includes a first target virtual object, and
the processing circuitry is configured to:
control a user-controlled virtual object to shoot the first target virtual object in response to the shooting operation on the first target virtual object; and
control the first target virtual object to move in the virtual scene in response to the first target virtual object being hit by the shooting operation.

15. The virtual resource display apparatus according to claim 14, wherein the processing circuitry is configured to:
control the first target virtual object to move in the virtual scene by a target distance in response to the first target virtual object being hit once by the shooting operation.

16. The virtual resource display apparatus according to claim 13, wherein
the at least one target virtual object includes a first target virtual object and a second target virtual object; and
the processing circuitry is configured to display the target virtual resource in the virtual scene in response to the first target virtual object reaching a first target location and the second target virtual object reaching a second target location.

17. The virtual resource display apparatus according to claim 16, wherein the processing circuitry is configured to:
display the target virtual resource in the virtual scene in response to the first target virtual object reaching the first target location before the second target virtual object reaches the second target location.

18. The virtual resource display apparatus according to claim 13, wherein the processing circuitry is configured to:
display the at least one target virtual object at an initial display location of the at least one target virtual object in the virtual scene in response to the at least one target virtual item of the virtual scene reaching the target state; and
display the at least one target virtual object at the initial display location without display of the target virtual resource in response to the location of the at least one target virtual object meeting a second target condition.

19. The virtual resource display apparatus according to claim 18, wherein
the at least one target virtual object includes a first target virtual object and a second target virtual object; and
the processing circuitry is configured to display the at least one target virtual object at the initial display location without the display of the target virtual resource in response to the first target virtual object not reaching a first target location when the second target virtual object reaches a second target location.

20. A non-transitory computer-readable storage medium storing instructions which when executed by at least one processor cause the at least one processor to perform:
displaying at least one target virtual object in a virtual scene in response to at least one target virtual item of the virtual scene reaching a target state through user interaction;
controlling the at least one target virtual object to move in the virtual scene in response to a shooting operation on the at least one target virtual object; and
displaying a target virtual resource in the virtual scene in response to a location of the at least one target virtual object meeting a first target condition.
